(19) United States
(12) Patent Application Publication
(10) Pub. No.: US 2026/0193734 A1
(43) Pub. Date: Jul. 9, 2026

(54) METHOD FOR PRODUCING VALUABLE METALS

(71) Applicant: SUMITOMO METAL MINING CO., LTD., Tokyo (JP)

(72) Inventors: Rio Kuromitsu, Niihama-shi (JP); Takuya Kaseyama, Niihama-shi (JP)

(73) Assignee: SUMITOMO METAL MINING CO., LTD., Tokyo (JP)

(21) Appl. No.: 19/132,608

(22) PCT Filed: Nov. 6, 2023
(86) PCT No.: PCT/JP2023/039914

§ 371 Date: May 23, 2025

(30) Foreign Application Priority Data
Nov. 30, 2022 (JP) 2022191706

(51) Int. Cl. C22B 7/00; C01B 32/05; C22B 1/02; C22B 1/248; H01M 10/54

(52) U.S. Cl. CPC C22B 7/001; C01B 32/05; C22B 1/02; C22B 1/248; H01M 10/54

(57) ABSTRACT

The present invention is a method for producing valuable metals from a feedstock containing waste lithium-ion cells, wherein the method comprises: a pulverization step S1 for pulverizing a feedstock containing waste lithium-ion cells to produce a pulverized material; a sieving step S2 for sieving the pulverized material; a roasting step S3 for roasting the undersize material and decomposing organic matter contained in the undersize material; a flotation step S4 for subjecting the resulting roasted material to a flotation process, and recovering at least carbon obtained by decomposing the organic matter in the roasting step S3; a melting step S5 for heating the resulting flotation product and performing reduction melting of the flotation product, and obtaining a melt containing slag and metals including valuable metals. In the roasting step S3, the undersize material is roasted at a temperature of 300° C. to 600° C. inclusive.

### TECHNICAL FIELD

The present invention relates to a method for producing valuable metals from waste lithium-ion batteries.

### BACKGROUND ART

In recent years, lithium-ion batteries have become popular as light-weight, high-output secondary batteries. Well-known lithium-ion batteries have a structure in which a negative electrode material, a positive electrode material, a separator and an electrolyte are sealed in an outer packaging can. For example, the outer packaging can is configured from a metal such as aluminum (Al) or iron (Fe). In addition, the negative electrode material is configured from a negative electrode active material (graphite, etc.) fixed to a negative electrode collector (copper foil, etc.), and the positive electrode material is configured from a positive electrode active material (lithium nickelate, lithium cobaltate, etc.) fixed to a positive electrode collector (aluminum foil, etc.). In addition, the separator is configured from a porous resin film of polypropylene, and the electrolytic solution is configured to include an electrolyte such as lithium hexafluorophosphate (LiPF₆).

Hybrid vehicles and electric vehicles are some of the main applications of lithium-ion batteries, and there is an expectation of the installed lithium-ion batteries being discarded in large volumes, together with the life-cycle of automobiles in the future. As the reuse method of waste lithium-ion batteries (also simply referred to as “waste batteries”), the pyrometallurgical smelting process of completely melting these waste batteries in a high-temperature furnace has been proposed.

In the waste lithium-ion batteries, impurity components such as carbon (C), aluminum, fluorine (F) and phosphorus (P) are contained in addition to the valuable metals such as nickel (Ni), cobalt (Co) and copper (Cu). For this reason, it is necessary to remove these impurity components to recover the valuable metals from the waste lithium-ion batteries. In particular, among these impurity components, carbon hinders the separability of metal and slag if left behind. In addition, carbon may hinder the proper oxidative removal of other substances, due to serving as a reducing agent. As such a method of removing carbon, there is oxidative roasting which performs roasting at a temperature of about 800° C., while blowing air or oxygen.

For example, Patent Document 1 discloses a method for recovering valuable metals from waste batteries for which stable control of the oxidation extent in the melting step becomes possible, which has been difficult conventionally, by providing a pre-oxidation step of performing oxidation treatment before a dry process, and thus enables the valuable metals to be recovered at a high recovery ratio in a stable manner.

However, upon recovering a valuable metal by a pyrometallurgical smelting process from a feedstock containing waste cells, technology related to effectively recovering this valuable metal while reducing the carbon dioxide emissions has not been proposed thus far.

### CITATION LIST

### Patent Document

Patent Document 1: Japanese Patent No. 5434934

### DISCLOSURE OF THE INVENTION

### Problems to be Solved by the Invention

The present invention has been proposed in view of such a situation, and has an object of providing technology related to a method for recovering and producing valuable metals by a pyrometallurgical smelting process from a feedstock containing waste lithium-ion batteries, which can effectively recover valuable metals, while decreasing carbon dioxide emissions.

### Means for Solving the Problems

The present inventors have given careful consideration to solve the above problem. As a result, it was found that valuable metals could be effectively recovered while reducing carbon dioxide emissions, by pulverizing a feedstock including waste lithium-ion batteries, sieving the obtained pulverized product and performing a roasting treatment at a predetermined temperature on the obtained undersieve material, thereby decomposing organic matter contained in this undersieve material, and subsequently conducting flotation processing on the roasted product, and separating and recovering carbon obtained by the organic matter being decomposed, thereby arriving at completion of the present invention.

(1) A first aspect of the present invention is a method for producing valuable metals from a feedstock containing waste lithium-ion batteries, the method including: a pulverizing step of pulverizing the feedstock containing the waste lithium-ion batteries to make a pulverized product; a sieving step of sieving the pulverized product; a roasting step of roasting an obtained undersieve material, and decomposing organic matter contained in the undersieve material; a flotation step of subjecting a roasted product obtained in the roasting step to flotation processing, and recovering at least carbon obtained by decomposing organic matter in the roasting step; and a melting step of heating to reduce and melt a flotation mineral obtained in the flotation step, and obtaining a melt containing slag and a metal including the valuable metal, in which the roasting step roasts the undersieve material at a temperature of 300° C. or higher and 600° C. or lower.

(2) A second aspect of the present invention is a method for producing valuable metals as in the first aspect, in which the roasting step roasts the undersieve material at a temperature of 300° C. or higher and less than 500° C.

### Effects of the Invention

According to the present invention, it is possible to effectively recover valuable metals, while decreasing the carbon dioxide emissions.

### BRIEF DESCRIPTION OF THE DRAWINGS

FIG. 1 is a process diagram showing an example of the flow of a method for producing valuable metals.

### PREFERRED MODE FOR CARRYING OUT THE INVENTION

Hereinafter, a specific embodiment of the present invention (hereinafter referred to as “present embodiment”) will be described. It should be noted that the present invention is not to be limited to the following embodiment, and various modifications thereto are possible within a scope not changing the gist of the present invention.

A method according to the present embodiment is a method for producing valuable metals by separating and recovering from a feedstock containing waste lithium-ion batteries. Therefore, it can also be called a method for recovering valuable metals. The method related to the present embodiment is a method according to a pyrometallurgical smelting process mainly; however, it may be configured from a pyrometallurgical smelting process and a hydrometallurgical process.

Conventionally, a method for recovering valuable metals by a pyrometallurgical smelting process from a raw material including waste lithium-ion batteries has been known; however, a method for effectively recovering valuable metals while decreasing the emissions of carbon dioxide has been demanded.

The majority of the emissions of carbon dioxide in the pyrometallurgical smelting process are accounted for by substances (about 39%) from carbon contained in the feedstock, and fuel (about 26%) used in the oxidative roasting method performed for carbon removal in the feestock. The carbon in the raw material is included as a binder such as polyvinylidene fluoride (PVDF), attaching and adhering to the positive electrode active material constituted by nickel (ni) or cobalt (Co), which are valuable metals, mainly.

Alternatively, it is contained as a constituent material of the negative electrode active material.

In the method related to the present embodiment, as the removal method of carbon in the feedstock, it is configured to change from the conventional oxidative roasting method to a flotation method, thereby reducing the emissions of carbon dioxide from the feedstock containing waste lithium-ion batteries.

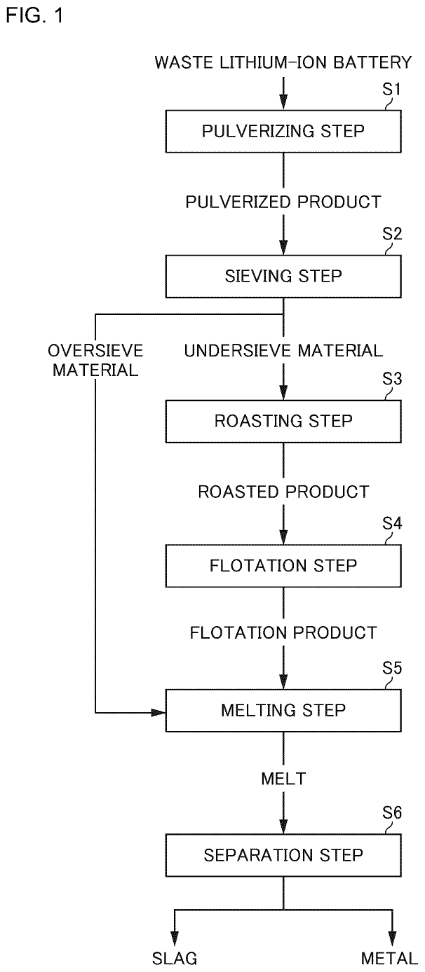

More specifically, FIG. 1 is a process diagram showing an example of the flow of the method according to the present embodiment. This method includes: a pulverizing step S1 of pulverizing the feedstock containing waste lithium-ion batteries to create a pulverized product; a sieving step S2 of sieving the pulverized product; a roasting step S3 of roasting the undersieve material to decompose the organic matter contained in this undersieve material; a flotation step S4 of subjecting the roasted product to flotation processing, and recovering at least the carbon obtained by decomposing the organic matter in this roasting step; and a melting step S5 of heating the flotation product and reductively melting to obtain a molten product (reduced product) containing slag and metal. In addition, by separating the slag and melt from the molten product, it is possible to recover the metal (separation step S6).

According to such a method, it is possible to efficiently recover valuable metals by effectively removing the carbon contained in a feedstock containing waste lithium-ion batteries, while reducing the emissions of carbon dioxide. It should be noted that, due to reducing the emissions of carbon dioxide, it can also be said that carbon can be separated and recovered without removing (combustive removal) the carbon.

### (Pulverization Step)

The pulverization step S1 is a step which is a pretreatment performed for subjecting the feedstock containing waste lithium-ion batteries to a pyrometallurgical smelting process, and is a step conducting the pulverization process on the feedstock.

The pulverization process can be performed using a pulverizer. The pulverizer is not particularly limited, and can employ a device generally used thereas.

It should be noted that it is preferable to perform removal of electrolytic solution contained in the waste lithium-ion batteries before performing the pulverization process. The removal of electrolytic solution can be performed by drilling the waste lithium-ion cell, for example. In addition, it is preferable to perform the removal of the outer packaging can from the pulverized product obtained by the pulverization process. For the removal of the outer packaging, in the case of this outer packaging can being aluminum (Al), it is possible to remove by segragating the pulverized product obtained from pulverizing with an aluminum sorting machine, and in the case of iron (Fe), by segragating the pulverized product with a magnetic separator.

### (Sieving Step)

The sieving step S2 is a step of sieving the pulverized product obtained in the pulverization step S1 with a sieve of predetermined mesh. By sieving the pulverized product of the waste lithium-ion batteries in this way, a powder containing lithium nickelate or lithium cobaltate, which are positive electrode active materials, is obtained as the undersize (undersieve material), and a powder containing a part of the carbon constituting the binder fixing these positive electrode active materials is obtained. Alternatively, the carbon that is the negative electrode active material is obtained.

On the other hand, as the oversieve material obtained by sieving, a mixture of aluminum foil, which is the negative electrode collector, and copper foil, which is the positive electrode collector, is obtained. It should be noted that, since copper (Cu), which is a valuable metal, is contained in the mixture consituting such an oversieve material, it is possible to subject to the processing in the melting step S5 described later, and melt together with the flotation production obtained in the flotation step S4.

### (Roasting Step)

The roasting step S3 is a step of roasting the undersieve material obtained in the sieving step S2, and is roasting for enabling to effectively and efficiently separate and recover the carbon in the processing of the flotation in the subsequent flotation step S4.

As mentioned above, carbon is contained in the feedstock containing waste lithium-ion batteries, in the form of a binder such as polyvinylidene fluoride around the lithium nickelate and lithium cobaltate, which are the positive electrode active materials. Such carbon constitutes the undersieve material together with nickel, cobalt, etc.; therefore, by performing the flotation processing described later, carbon is separated and removed from the valuable metals such as nickel and cobalt. However, at least part of the carbon fixes as organic binder around the lithium nickelate and lithium cobaltate, and thus becomes a hinderance to separation by flotation.

Therefore, ub the method according to the present embodiment, before subjecting the undersieve naterial to the flotation processing, by roasting this undersieve material at a predetermined temperature, it is configured so as to decompose the organic matter constituted from carbon (binders such as PVDF). By such a roasting treatment, it is possible to release the fixation between the valuable metals and carbon, and in the subsequent flotation processing, it is possible to efficiently separate and recover the carbon including that obtained by decomposition of the organic matter such as PVDF.

Herein, the calcination treatment on the undersieve releases the fixation of the valuable metals and carbon by decomposition of the organic matter, and does not evaporatively remove the organic matter containing carbon. Therefore, the temperature of the roasting treatment (roasting temperature) is set to the range of 300° C. or higher and 600° C. or lower.

From the viewpoint of the decomposition temperature of a general binder compound including PVDF, the roasting temperature is preferably 300° C. or higher. When the roasting temperature is less than 300° C., decomposition of organic matter does not completely finish and is insufficient, and thus the fixation between the valuables metal and carbon cannot be released, and there is a possibility of not being able to separate carbon in the flotation processing described later.

On the other hand, the roasting temperature is preferably 600° C. or lower. If the roasting temperature exceeds 600° C., the organic matter constituting the binder may mostly volatalize, and thus no longer remain in the obtained roasted product. Given this, it will no longer be possible to separate and recover carbon in the flotation processing described later. Moreover, if the organic matter combusts and volatilizes by roasting at a temperature exceeding 600° C., since the carbon dioxide emissions increase, it is will no longer be possible to realize an operation for which the carbon dioxide emissions are reduced.

In addition, the roasting temperature is more preferably set to the range of 300° C. or higher and less than 500° C. In the roasting treatment on the undersieve material containing organic matter, oxidation of carbon may start from a temperature range of about 450° C. or higher and 500° C. or lower. By setting the roasting temperature more preferably to 300° C. or higher and less than 500° C., the combustion of this organic matter (carbon) is curbed, and it is possible to more effectively carry out decomposition of the organic matter without increasing the carbon dioxide emissions.

The roasting treatment, for example, can be carried out using common equipment such as a rotary kiln or rotary hearth furnace. In addition, as the atmosphere of the roasting treatment, although establishing an air atmosphere is preferable from the viewpoint of curbing the operation cost, an inert gas such as nitrogen may be introduced to establish an inert gas atmosphere in order to curb combustion of carbon upon raising the decomposition reaction rate by raising the roasting temperature, for example. In the case of introducing an inert gas, for example, it is possible to introduce so that the oxygen concentration is prefearbly 15% or less, more preferably 10% or less, and even more preferably 5% or less.

In addition, as the roasting time, it is sufficient if a time enabling the organic component such as PVDF contained in the undersieve material to sufficiently decompose, and may be appropriately set according to the treatment amount, etc.

### (Flotation Step)

The flotation step S4 is a step that subjects the roasted product obtained in the roasting step S3 to flotation processing in order to separate and remove carbon from this roasted product. In this way, the flotation processing separates the particles of valuable metals such as nickel and cobalt from the roasted product, and carbon decomposed from the organic matter by the treatment in the aforementioned roasting step. It should be noted that, in the flotation processing, at least the carbon component is separated as suspended matter.

In the floatation treatment, similarly to common treatments, it is possible to carry out by adding a collector, foaming agent, etc. The collector and foaming agent are not particularly limited so long as being able to float the carbon for separation and recovery. For example, as the collector, an oil-based collector having hydrocarbon groups such as diesel oil and kerosene, tar oil, and the like can be exemplified, and thereamong, it is preferable to use kerosene. In addition, as the foaming agent, nonionic flotation agents of an aromatic alcohol system, pine oil of an unsaturated hydrocarbon group system, or the like can be exemplified, and thereamong, it is preferable to use methyl isobutyl carbinol (MIBC).

In addition, as the flotation device, it is possible to use a known device such as a Denver floatation machine.

### (Melting Step)

The melting step S5 is a step of heating to reduce and melt the flotation minerals obtained in the flotation step S4, and obtaining a melt (reduced substance) containing slag and metals including the valuable metals. It should be noted that the flotation mineral which is the treatment target is configured from particulates containing the valuable metals such as nickel and cobalt from which carbon was separated in the aforementioned flotation processing.

The melting process charges the flotation minerals which are the treatment target to a melting furnace such as an electric furnace, and reduces and melts the flotation minerals by heating at a predetermined melting temperature. By such a melting treatment, it is possible to make an alloy in which the valuable metal (Cu, Ni, Co, etc.) is reduced and integrated, while metals having low added value contained in the flotation minerals are made into oxides (slag). It should be noted that, although the melt containing slag and metal is obtained by melting treatment in this way, in the melt, a slag layer is formed on the upper side and a metal layer is formed on the lower side due to the specific gravity difference.

As a target of the melting treatment, it is possible to further add the oversieve material sieved in the sieving step S2. As described above, a mixture including copper foil, which is the positive electrode collector, for example, may be included in the oversieve material. Therefore, by also collectively subjecting such oversieve material to the melting treatment, it is possible to also effectively recovery copper, which is a valuable metal.

The melting treatment preferably introduces a reducing agent. It is possible to use a known agent as the reducing agent, and is not particularly limited; however, it preferably contains carbon atoms which can easily reduce oxides of copper, nickel, cobalt, etc. which are the valuable metals that are the recovery target. More specifically, it is preferable to use carbon and/or carbon monoxide as the reducing agent. Carbon has the ability to easily reduce the valuable metals (Cu, Ni and Co) that are the recovery target. For example, it is possible to reduce 2 moles of the valuable metal oxide (copper oxide, nickel oxide, etc.) with 1 mole of carbon. In addition, the reduction method using carbon or carbon monoxide has very high stability compared to a method using a metal reducing agent (for example, thermite reaction method using aluminum).

The alloy generated by the melting treatment contains the valuable metal, as mentioned above. For this reason, it becomes possible to separate components containing valuable metal (alloy) from other components (slag) in the melt (reduced substance). This is because the valuable metal has low oxygen affinity relative to metals having low added value (Al, etc.) which has high oxygen affinity.

Flux can be added in the melting treatment. Silicon dioxide (SiO₂), and calcium oxides such as calcium oxide (CaO) and calcium carbonate (CaCO₃) can be exemplified as the flux.

As the temperature of the melting treatment (melting temperature), it is sufficient so long as being set according to the melting point of the generated slag; however, it is preferable to set to the range of 1300° C. or higher and 1600° C. or lower. If the melting temperature exceeds 1600° C., the thermal energy will be wastefully consumed, and wear on the heat resistant material used in the melting furnace becomes severe. In addition, if the melting temperature is less than 1300° C., separation of the slag layer and metal layer is not sufficiently carried out, and there is a possibility of a sufficient temperature no longer being maintanable in order to maintain the metal layer formed under the slag layer in the molten state.

As the equipment used in the melting treatment, it is sufficient so long as being equipment which can efficiently heat the flotation minerals that are the feedstock, and it is possible to use an electric furnace, for example. In addition, it is preferable to use a submerged arc furnace capable of efficiently heating by immersing the electrode into the slag.

### (Separation Step)

The separation step S6 is a step of separating the slag and the metal from the melt (reduced substance) obtained by melting the flotation minerals in the melting step S5, and recovering the metal containing valuable metals.

As described above, in the melt, a slag layer is formed on the upper side and a metal layer is formed on the lower side due to the specific gravity difference. Therefore, by discharging the slag from a slag hole, and the metal from a metal hole, each provided in the electric furnace by tapping, it is possible to separate and recover each of the slag and the metal. It should be noted that the discharge method of slag and metal is not limited to tapping, and may be configured so as to pour out by tilting the furnace.

### EXAMPLES

Hereinafter, a more specific description will be provided by showing examples of the present invention, but the present invention is not to be limited in any way to the following examples.

### EXAMPLES

### (Pulverizing Step)

As waste lithium-ion batteries, used cells of 18650-type cylindrical batteries, and automotive rectangular batteries, and defective products recovered in the cell manufacturing process were prepared. After discharging these waste lithium-ion batteries by immersing in salt water, the moisture was removed and the electrolytic solution was decomposed and removed by roasting in the atmospheric air at a temperature of 260° C., thereby obtaining cell contents.

The obtained cell contents were pulverized by a pulverizer (tradename Good Cutter, manufactured by Ujiie Manufacturing Co., Ltd.), to obtain a pulverized product.

### (Sieving Step)

Next, the obtained pulverized product was sieved with a sieve with 2 mm openings. A powder in which part of the carbon is adhered and bound as binder to the lithium nickelate or lithium cobaltate, which are the positive electrode active material, was obtained as the undersieve material. In addition, as the undersieve material, a granular product of carbon, which is the negative electrode active material, was also obtained. In addition, as the oversieve material, a mixture of aluminum foil, which is the negative electrode collector, and copper foil, which is the positive electrode collector, was obtained.

### (Roasting Step)

Next, 250 g of sample obtained as the undersieve material in the sieving step was charged into an alumina box bowl, and was held at temperatures of 350° C., 450° C. and 550° C. under an atmospheric air environment for 8 hours to roast.

### (Flotation Step)

Next, 0.008 g of kerosene was added in a proportion of 40 g/t as the collector to 200 g of the roasted product obtained by roasting, and 0.012 g of MIBC was charged in a proportion of 60 g/t as a flotation agent to pulp of 10% concentration prepared by adding 1800 g of water, and concentration was performed (also referred to as roughing). More specifically, bubbling was carried out for 10 minutes, and the solid matter floating together with the bubbles was recovered as carbon-containing material (90% by mass or more carbon content). In addition, the precipitate was filtered to recover the valuable metal-containing material (about 40% by mass in Cu, Ni and Co total content).

Next, concentration (also referred to as cleaning) was carried out again on the obtained carbon-containing material. More specifically, bubbling was performed for 8 minutes, and the solid floating together with the bubbles was recovered as the carbon-containing material (90% by mass or more carbon content). In addition, the precipitate was filtered to recover as the valuable metal-containing material (about 40% by mass in Cu, Ni and Co total content).

Furthermore, a second time cleaning was performed on the obtained carbon-containing material. More specifically, bubbling was performed for 5 minutes, and the solid floating together with the bubbles was recovered as the carbon-containing material (90% by mass or more of carbon content). In addition, the precipitate was filtered to recover as the valuable metal-containing material (about 40% by mass in Cu, Ni and Co total content).

Finally, a third time cleaning was performed on the obtained carbon-containing material. More specifically, bubbling was performed for 3 minutes, and the solid floating together with the bubbles was recovered as the carbon-containing material (90% by mass or more of carbon content). In addition, the precipitate was filtered to recover as the valuable metal-containing material (about 40% by mass in Cu, Ni and Co total content).

In this way, by performing the flotation processing of one time roughing and three times cleaning, and performing separation and removal of carbon, the solids floating together with the bubbles was recovered as the carbon-containing material (90% by mass or more of carbon content). In addition, the precipitate was filtered to recover as the valuable metal-containing material (about 40% by mass in Cu, Ni and Co total content). It should be noted that, upon the processing of cleaning, 0.006 g of MIBC was respectively charged in the proportion of 30 g/t.

After filtering the product precipitated at the bottom of the flotation device, it was dried at 110° C. to recover as the flotation product.

### (Melting Step)

Next, 10 g of the flotation product obtained in the flotation step was charged to an alumina crucible, 0.58 g of CaO as flux, and 0.78 g of graphite as reducing agent were charged thereto, and then heated at a temperature of 1550° C. and held for 1 hour to carry out the melting treatment. The melt containing slag and metal (alloy) containing the valuable metals was thereby obtained.

### (Separation Step)

The obtained melt was furnace cooled, and after cooling, the slag and metal (alloy) were separated and recovered. The recovered alloy was analyzed by ICP method, and the recovery ratio (mass %) of cobalt was calculated.

### COMPARATIVE EXAMPLES

In the Comparative Examples, contrary to the aforementioned example, the calcination step and flotation step were not performed, and a pre-oxidation step of pre-oxidizing the undersieve material sieved in the sieving step was provided prior to the melting step, and the carbon removal processing was performed. Then, the pre-oxidized product after the pre-oxidation treatment was subjected to the melting step, and the melting treatment was performed. It should be noted that, other than this, processing was carried out similarly to the Example.

More specifically, in the pre-oxidation step of the Comparative Examples, 21 to 25 g of sample (undersieve material) was charged into an alumina crucible, and processing was conducted under a nitrogen atmosphere while elevating the temperature to 900° C. and 1100° C., and holding for 30 minutes, by blowing respective predetermined amounts of oxygen through an alumina tube.

In addition, in the melting step, after 7.2 g of mixed flux having a SiO₂/CaO ratio of 1 was added to the oxidized sample obtained by the pre-oxidation step (pre-oxidized product), the melting treatment was performed in a nitrogen atmosphere by heating at a temperature of 1450° C. to 1500° C. and holding for 1 hour. It should be noted that, at this time, the oxygen blowing was not performed.

Then, the sample was furnace cooled, and after cooling, the slag and metal (alloy) were separated and recovered, the recovered alloy was analyzed by the ICP method, and the recovery ratio (mass %) of cobalt was calculated.

### (Results)

The processing conditions of the Examples and Comparative Examples, and the results for the cobalt recovery ratio are shown in the following Table 1. In addition, the increase/decrease ratios of carbon (C) over all steps were calculated. It should be noted that, concerning the evaluation of the increase/decrease ratio of C in the table, the proportion of matter from carbon contained in the feedstock among the carbon dioxide emissions was set as 39%, and the C reduction ratio in (1) flotation step was calculated from “39(%)×(1−volatilization ratio^{※2})×C recovery ratio”. In addition, concerning (4) CO₂ reduction ratio in the table, it was calculated from “(1) C reduction ratio−(2) C increase ratio+(3) C reduction ratio”.

TABLE 1

| | | | | | | Compar- | Compar- | Compar- | Compar- | Compar- |
|---|---|---|---|---|---|---|---|---|---|---|
| | | | | | | ative | ative | ative | ative | ative |
| | | | Example | Example | Example | Example | Example | Example | Example | Example |
| | | | 1 | 2 | 3 | 1 | 2 | 3 | 4 | 5 |
| Roasting step | | Temperature | 350 | 450 | 550 | — | — | — | — | — |
| | | (° C.) | | | | | | | | |
| C recovery ratio in flotation step | | (%) | 70 | 95 | 95 | — | — | — | — | — |
| Pre-oxidation step | | Temperature | — | — | — | 1100 | 1100 | 1100 | 900 | 1100 |
| | | (° C.) | | | | | | | | |
| | | Oxygen | — | — | — | 12.5 | 11 | 11 | 9.5 | 6 |
| | | amount (L) | | | | | | | | |
| Melting step | | Temperature | 1550 | 1550 | 1550 | 1450~1500 | | | | |
| | | (° C.) | | | | | | | | |
| Cobalt recovery ratio | | (mass %) | 99 | 99 | 99 | 78 | 92 | 90 | 96 | 93 |
| Increase/ | (1) C reduction ratio | (%) | 19 | 20 | 15 | — | — | — | — | — |
| decrease | in flotation step | | | | | | | | | |
| ratio of | (2) C increase ratio | (%) | 8 | 11 | 13 | — | — | — | — | — |
| C over | from fuel in | | | | | | | | | |
| all steps | roasting step | | | | | | | | | |
| | (3) C reduction ratio | (%) | 26 | 26 | 26 | 0 | 0 | 0 | 8 | 0 |
| | in pre-oxidation step | | | | | | | | | |
| | (4) CO2 reduction | (%) | 36 | 36 | 28 | 0 | 0 | 0 | 5 | 0 |
| | ratio (compared to | | | | | | | | | |
| | the conventional) | | | | | | | | | |

| | | | | | | | | |
|---|---|---|---|---|---|---|---|---|
| ※1 CO2 emission (%) (from heating) compared to | 32 | 41 | 50 | — | — | — | — | — |
| roasting step | | | | | | | | |
| ※2 C volatilization ratio (%) in roasting step | 32 | 45 | 49 | — | — | — | — | — |

As is evident from Table 1, when comparing the Examples in which the carbon recovery processing was performed by flotation before the melting step, and the Comparative Examples in which carbon removal processing was performed by oxidation treatment in the pre-oxidation step, while there was no great change in the cobalt recovery ratio, the carbon dioxide emissions could be greatly reduced in the Example.

More specifically, in Examples 1 to 3, while about 30% to 60% carbon dioxide was generated relative to the Comparative Examples in the roasting step (※1 in the table), by not performing the pre-oxidation step as in the Comparative Examples, which are conventional examples, it is possible to decrease the carbon dioxide emissions by 26% compared to conventional. Additionally, it is possible to decrease the carbon dioxide emissions of ((4) in Table) on the order of 28% to 36% or more in total, from the carbon recovery content of 2% to 12% (“(1)-(2)” in the table) in the roasting step and flotation step.

1. A method for producing valuable metals from a feedstock containing waste lithium-ion batteries, the method comprising:
a pulverizing step of pulverizing the feedstock containing the waste lithium-ion batteries to make a pulverized product;
a sieving step of sieving the pulverized product;
a roasting step of roasting an obtained undersieve material, and decomposing organic matter contained in the undersieve material;
a flotation step of subjecting a roasted product obtained in the roasting step to flotation processing, and recovering at least carbon obtained by decomposing organic matter in the roasting step; and
a melting step of heating to reduce and melt a flotation mineral obtained in the flotation step, and obtaining a melt containing slag and a metal including the valuable metal,
wherein the roasting step roasts the undersieve material at a temperature of 300° C. or higher and 600° C. or lower.

2. The method for producing valuable metals according to claim 1, wherein the roasting step roasts the undersieve material at a temperature of 300° C. or higher and less than 500° C.
